(19) United States
(12) Patent Application Publication
(10) Pub. No.: US 2024/0119473 A1
(43) Pub. Date: Apr. 11, 2024

(54) RATE ADJUSTMENT METHOD AND RATE ADJUSTMENT SYSTEM USED TO GENERATE ESTIMATED RATES TO GENERATE ESTIMATED REVENUE FOR OPTIMIZING RATE ESTIMATION MODEL ACCORDINGLY

(71) Applicant: DUN-QIAN Intelligent Technology Co., Ltd., Taichung City (TW)

(72) Inventors: Yen-Chu Chen, Chiayi City (TW); Ling-Jung Lin, Tainan City (TW); Shao-Chen Liu, Taichung City (TW); Hsuan-Wei Chen, Taichung City (TW); Shuh-Shian Tsai, New Taipei City (TW)

(73) Assignee: DUN-QIAN Intelligent Technology Co., Ltd., Taichung City (TW)

(21) Appl. No.: 18/088,783

(22) Filed: Dec. 27, 2022

(30) Foreign Application Priority Data
Oct. 7, 2022 (TW) 111138118

(51) Int. Cl. G06Q 30/0201; G06Q 50/14

(52) U.S. Cl. CPC G06Q 30/0206; G06Q 50/14

(57) ABSTRACT

A rate adjustment method includes a rate estimation model generating a plurality of estimated rates according to a plurality of training data, a revenue estimation model generating an estimated revenue according to the plurality of estimated rates, updating the rate estimation model according to the estimated revenue to generate an updated rate estimation model, and inputting a plurality of current data into the updated rate estimation model to update the plurality of estimated rates.

### BACKGROUND OF THE INVENTION

### 1. Field of the Invention

The disclosure is related to a rate adjustment method and a rate adjustment system, and more particularly, a rate adjustment method and a rate adjustment system used to generate a plurality of estimated rates to generate an estimated revenue for optimizing a rate estimation model accordingly.

### 2. Description of the Prior Art

Finding the best rate for an item whose rate changes over time (e.g. hotel room) can be a challenge. If the rate is set too low, although it may increase sales, the revenue may decrease because of the increased sales are not sufficient to compensate the reduced rate. However, if the rate is set too high, although the profit per sale is higher, it would lead to a decrease in sales, and per unit profit may not be sufficient to compensate the lost sales, detrimental to overall revenue. Therefore, managers have to set appropriate rates based on various factors.

Currently, when setting rates, it often relies too much on the experience of operators, or can only refer to sales records of comparable periods in the past. With these methods, optimal rates cannot be set effectively. Therefore, a better approach to set rates is in need.

### SUMMARY OF THE INVENTION

An embodiment provides a rate adjustment method including a rate estimation model generating a plurality of estimated rates according to a plurality of training data, a revenue estimation model generating an estimated revenue according to the plurality of estimated rates, updating the rate estimation model according to the estimated revenue to generate an updated rate estimation model, and inputting a plurality of current data into the updated rate estimation model to update the plurality of estimated rates.

Another embodiment provides a rate adjustment system including a training data module, a current data module, a rate estimation model and a revenue estimation model. The training data module is used to provide a plurality of training data. The current data module is used to provide a plurality of current data. The rate estimation model is linked to the training data module and the current data module, and used to receive the plurality of training data and the plurality of current data, generate a plurality of estimated rates according to the plurality of training data, and update the plurality of estimated rates according to the plurality of current data. The revenue estimation model is used to generate an estimated revenue according to the plurality of estimated rates and generate an updated estimated revenue after the plurality of estimated rates are updated. Each of the rate estimation model and the revenue estimation model has a neural network, and the rate estimation model is updated according to the estimated revenue for optimizing the rate estimation model.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a rate adjustment system according to an embodiment.

FIG. 2 illustrates a rate adjustment method according an embodiment.

FIG. 3 illustrates a rate adjustment method according another embodiment.

FIG. 4 illustrates a rate adjustment method according another embodiment.

FIG. 5 illustrates a rate adjustment method according another embodiment.

FIG. 6 illustrates a rate adjustment method according another embodiment.

### DETAILED DESCRIPTION

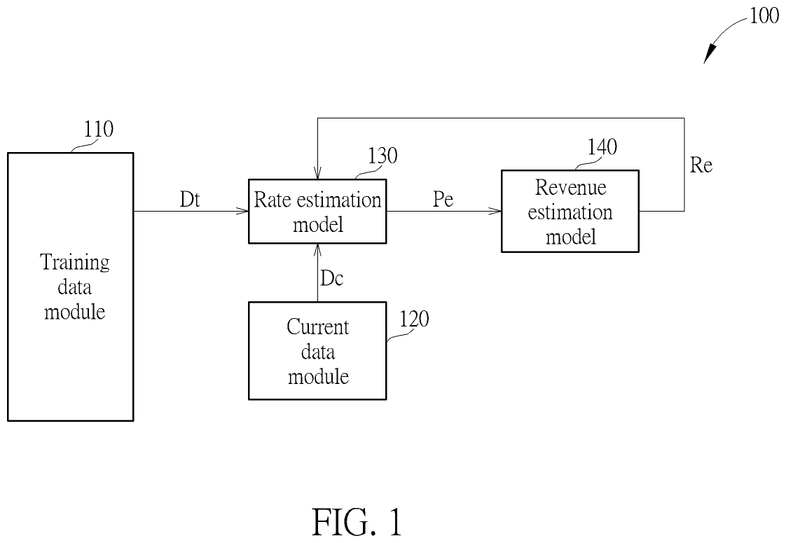

FIG. 1 illustrates a rate adjustment system 100 according to an embodiment. The rate adjustment system 100 can include a training data module 110, a current data module 120, a rate estimation model 130 and a revenue estimation model 140. The training data module 110 can provide a plurality of training data Dt. The current data module 120 can provide a plurality of current data Dc. The rate estimation model 130 can be linked to the training data module 110 and the current data module 120. The rate estimation model 130 can receive the training data Dt and the current data Dc, generate a plurality of estimated rates Pe according to the training data Dt, and update the estimated rates Pe according to the current data Dc. The revenue estimation model 140 can be linked to the rate estimation model 130 and include an elastic neural network, and the revenue estimation model 140 can generate an estimated revenue Re according to the estimated rates Pe and generate an updated estimated revenue Re after the estimated rates Pe are updated. In FIG. 1, the rate estimation model 130 can be updated according to the estimated revenue Re for optimizing the rate estimation model 130, and more details are described below.

Each of the rate estimation model 130 and the revenue estimation model 140 can have a neural network, so the rate estimation model 130 and the revenue estimation model 140 can be trained to improve the estimated rates Pe and estimated revenue Re generated by these two models.

The training data module 110, the current data module 120, the rate estimation model 130 and the revenue estimation model 140 can be implemented using hardware and software such as non-volatile memory, processor, browser, network interface, display, data bus, transmission interface, transmission wire and application program to perform data storage, calculation, control, data transmission and other related operations.

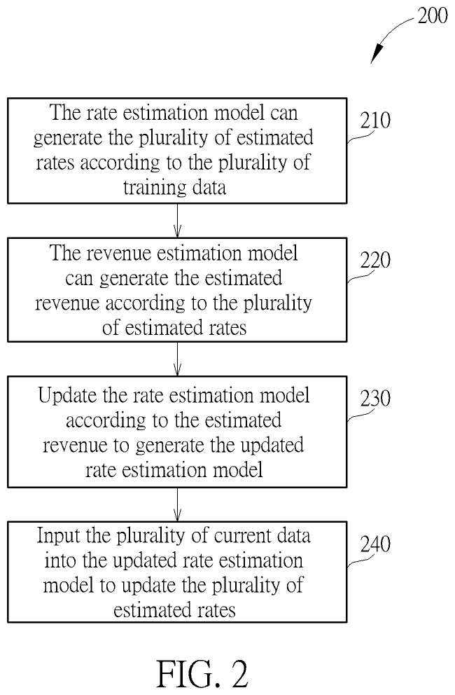

FIG. 2 illustrates a rate adjustment method 200 according an embodiment. The rate adjustment method 200 can include the following steps.

Step 210: the rate estimation model 130 can generate the plurality of estimated rates Pe according to the plurality of training data Dt;

Step 220: the revenue estimation model 140 can generate the estimated revenue Re according to the plurality of estimated rates Pe;

Step 230: update the rate estimation model 130 according to the estimated revenue Re to generate the updated rate estimation model 130; and

Step 240: input the plurality of current data Dc into the updated rate estimation model 130 to update the plurality of estimated rates Pe.

In Step 210, the training data module 110 can provide the training data Dt. In Step 230, the rate estimation model 130 can be updated multiple times to generate a plurality of estimated revenue Re to accordingly select an optimal rate estimation model 130. For example, if an updated rate estimation model 130 can generate estimated rates Pe corresponding to a highest estimated revenue Re, the updated rate estimation model 130 can be the optimal rate estimation model 130. The optimal rate estimation model 130 can be actually applied for generating rates. After generating the optimal rate estimation model 130 in Step 230, the current data Dc can be inputted into the optimal rate estimation model 130 to update the estimated rates Pe.

For example, the rate adjustment system 100 and the rate adjustment method 200 can be used to determine the rates of hotel rooms. In Step 210, the training data Dt can include weather data, news, economic data, historical sales data and/or online travel agency (OTA) data. For example, the online travel agency (OTA) data can be obtained using a web crawler. After inputting the training data Dt into the rate estimation model 130, the generated estimated rates Pe can include daily rates of a plurality dates, such as daily rates of a hotel room for the next 30 days, that is 30 rates in total.

Regarding the training data Dt, for example, if the weather is better, the hotel room sales may be higher. If the news (e.g. news about floral festival) is favorable for tourism, the hotel room sales may be higher. If the economic data (e.g. stock market data and travel subsidies) is favorable for tourism, the hotel room sales may be higher. If the historical sales data show the hotel room sales in a period are higher, the hotel room sales may be higher in the corresponding period. The online travel agency (OTA) data can provide room rates of other hotels in the area, such as room rates of competing hotels, as references for setting the hotel room rates. Hence, the training data Dt can include a variety of relevant data and be used to train the rate estimation model 130. In this way, relevant factors affecting the hotel room sales can be considered more comprehensively. It can avoid relying too heavily on the personal experiences of the operators and managers. It can also avoid relying on insufficient factors.

In Step 220, after inputting the estimated rates Pe into the revenue estimation model 140, the revenue estimation model 140 can estimate the sales according to the estimated rates Pe, and the estimated revenue Re can be generated accordingly. For example, if the estimated rates Pe are higher, the hotel room sales may be lower. If the estimated rates Pe are lower, the hotel room sales may be higher. Hence, the estimated rates Pe should be appropriate to yield the optimal estimated revenue Re. With the continuous accumulation of historical sales data, the actual revenue can be obtained, and the difference between the actual revenue and the estimated revenue Re generated by the revenue estimation model 140 can be compared, so as to gradually improve the rate estimation model 130 and the revenue estimation model 140.

In Step 230, the rate estimation model 130 can be updated to adjust the estimated rates Pe and the estimated revenue Re, and the rate estimation model 130 can be updated and optimized according to the updated estimated revenue Re. As mentioned above, the rate estimation model 130 corresponding to the highest estimated revenue Re can be an optimal model. In Step 240, the current data Dc can include weather forecast data, current news, current economic data, current sales data, and/or current online travel agency (OTA) data. In FIG. 1 and FIG. 2, the data types and data formats in the training data Dt and the current data Dc can be the same, so that the rate estimation model 130 can be optimized according to the training data Dt, and then the optimal rate estimation model 130 can use the current data Dc to estimate rates.

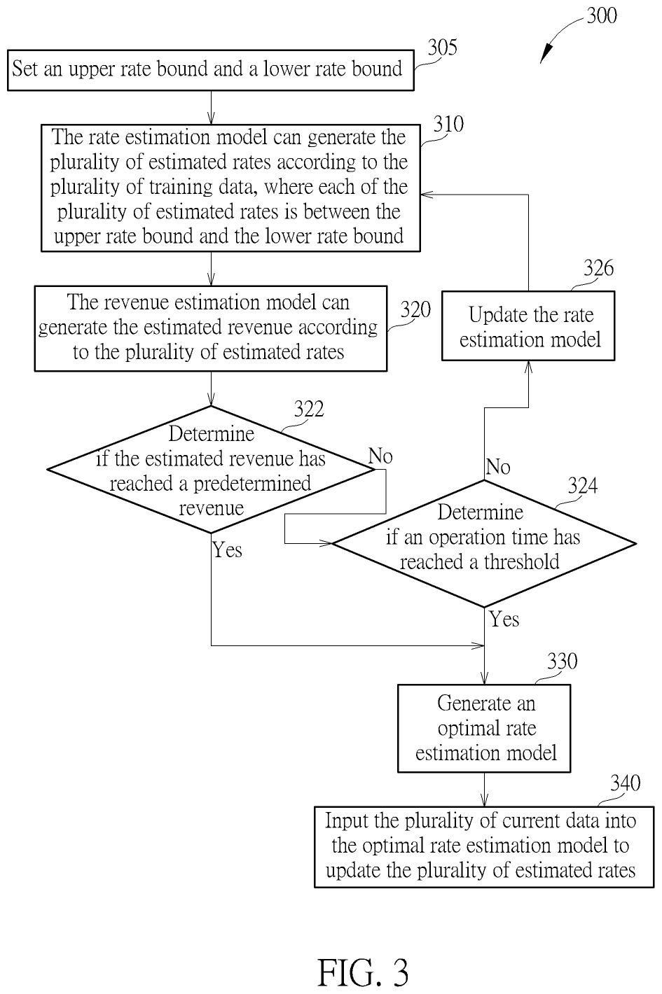

FIG. 3 illustrates a rate adjustment method 300 according another embodiment. In FIG. 3, more details are described. The rate adjustment method 300 can include following steps.

Step 305: set an upper rate bound (expressed as Pmax) and a lower rate bound (expressed as Pmin);

Step 310: the rate estimation model 130 can generate the plurality of estimated rates Pe according to the plurality of training data Dt, where each of the plurality of estimated rates Pe is between the upper rate bound Pmax and the lower rate bound Pmin;

Step 320: the revenue estimation model 140 can generate the estimated revenue Re according to the plurality of estimated rates Pe;

Step 322: determine if the estimated revenue Re has reached a predetermined revenue (expressed as Rtarget); if so, enter Step 330; else, enter Step 324;

Step 324: determine if an operation time has reached a threshold (expressed as Tmax); if so, enter Step 330; else, enter Step 326;

Step 326: update the rate estimation model 130; enter Step 310;

Step 330: generate an optimal rate estimation model 130; and

Step 340: input the plurality of current data Dc into the optimal rate estimation model 130 to update the plurality of estimated rates Pe.

In Step 305, the upper rate bound Pmax and the lower rate bound Pmin can be set. The upper rate bound Pmax is higher than the lower rate bound Pmin (i.e. Pmax>Pmin). Each of the estimated rates Pe generated Step 305 is between the upper rate bound Pmax and the lower rate bound Pmin. For example, the upper rate bound Pmax can be an upper bound limited by regulations, and the lower rate bound Pmin can be the cost of a hotel room.

Step 310 and Step 320 can be corresponding to Steps 210 and 220 of FIG. 2 respectively. In Step 322, if the estimated revenue Re has reached the predetermined revenue Rtarget, it means the rate estimation model 130 can be ready for use, and the rate estimation model 130 is no longer updated. In other words, the neural network in the rate estimation model 130 is no longer trained and updated. The rate estimation model 130 at this time can be the optimal rate estimation model 130 mentioned in Step 330.

In Step 322, if the estimated revenue Re fails to reach the predetermined revenue Rtarget, the flow can enter Step 324, and Step 324 can determine if the operation time has reached the threshold Tmax. If the operation time of updating the rate estimation model 130 has not reached the threshold Tmax, the flow can enter Steps 326 and 310 to continue training and updating the rate estimation model 130. If the operation time of updating the rate estimation model 130 has reached the threshold Tmax, the rate estimation model 130 is no longer updated. The rate estimation model 130 corresponding to the highest revenue of a plurality of estimated revenues Re can be selected as the optimal rate estimation model 130.

In Steps 326, 310 and 320, when the rate estimation model 130 is updated, whether the estimated rates Pe comply with a predetermined rule can be determined. If the estimated rates Pe fail to comply with the predetermined rule, the revenue estimation model 140 can perform a penalty operation to generate a lower estimated revenue Re. For example, penalty points can be set when specific conditions are met according to requirements. When calculating a total revenue in an epoch, the revenue can be adjusted using the penalty points according to the preset rate estimation rules. Here, an epoch is completed when all the training data is used at once and is defined as the total number of iterations of all the training data in one cycle for training the machine learning model. For example, the rate estimation rules can be like “A room rate on Saturday cannot be lower than 1,500 dollars. If the rule is violated, the penalty is 1,000 points”, or “A room rate cannot be lower than 1,000 dollars for three consecutive days. If the rule is violated, the penalty is 300 points” and so on. Penalties will affect the weights of the rate estimation model 130. If the estimated rates Pe generated by the rate estimation model 130 violate the predetermined rules, the number and content of violations can be recorded. When calculating the estimated revenue Re of this epoch, the corresponding penalty points will be deducted, so that the corresponding rate estimation model 130 is less likely to be selected as an optimal rate estimation model 130.

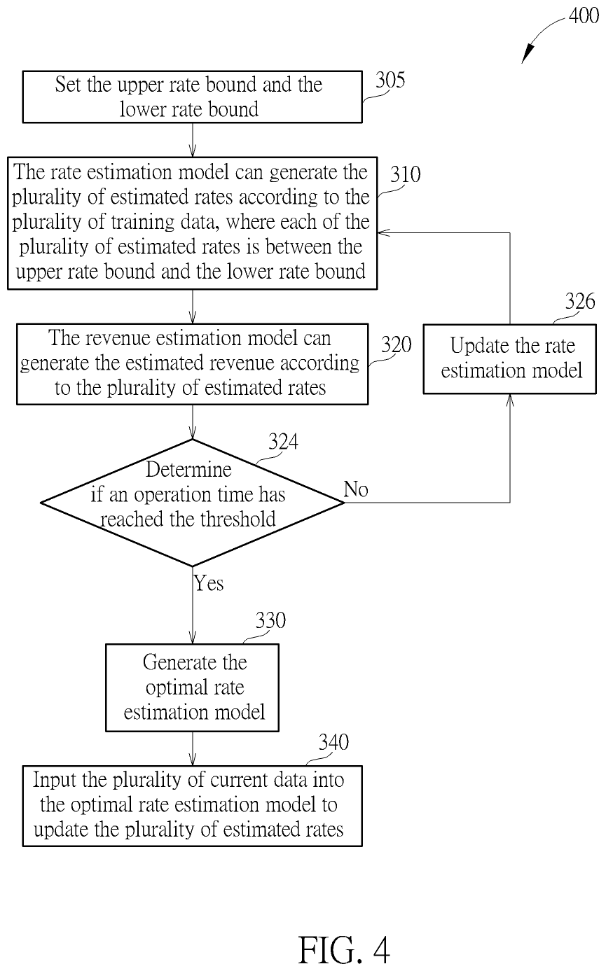

FIG. 4 illustrates a rate adjustment method 400 according another embodiment.

Compared to the rate adjustment method 300 in FIG. 3, Step 322 can be selectively omitted in the rate adjustment method 400. The rate adjustment method 400 can include the following steps.

Step 305: set an upper rate bound Pmax and a lower rate bound Pmin;

Step 310: the rate estimation model 130 can generate the plurality of estimated rates Pe according to the plurality of training data Dt, where each of the plurality of estimated rates Pe is between the upper rate bound Pmax and the lower rate bound Pmin;

Step 320: the revenue estimation model 140 can generate the estimated revenue Re according to the plurality of estimated rates Pe;

Step 324: determine if an operation time has reached the threshold Tmax; if so, enter Step 330; else, enter Step 326;

Step 326: update the rate estimation model 130; enter Step 310; Step 330: generate the optimal rate estimation model 130; and

Step 340: input the plurality of current data Dc into the optimal rate estimation model 130 to update the plurality of estimated rates Pe.

In FIG. 4, each of Steps 305 to 340 is described above, so it is not repeated. In FIG. 3 and FIG. 4, the threshold Tmax can be set according to the time of an training epoch.

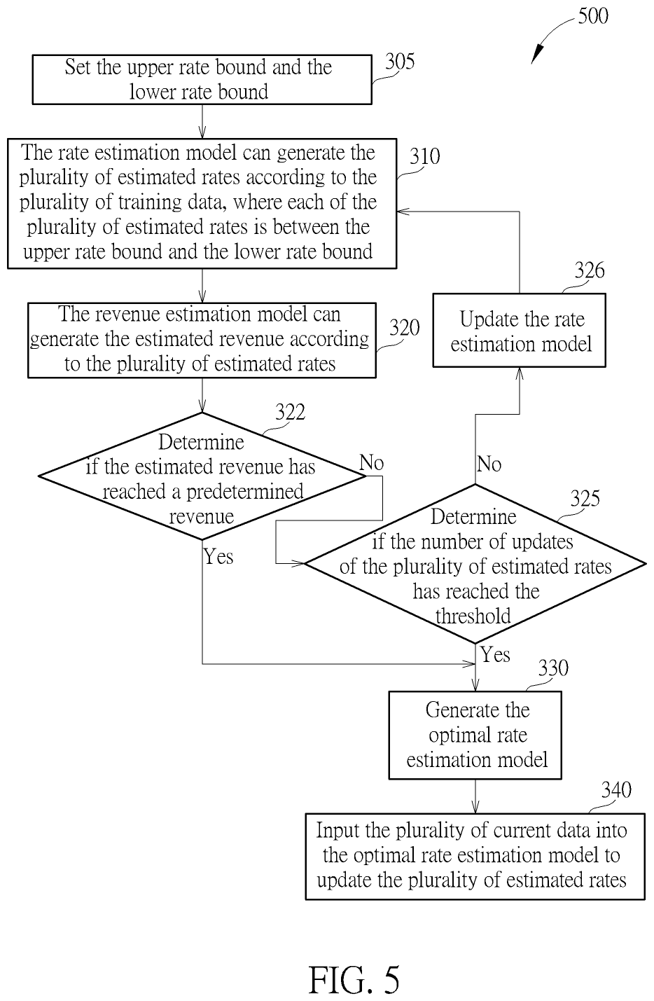

FIG. 5 illustrates a rate adjustment method 500 according another embodiment.

Compared to the rate adjustment method 300 in FIG. 3, Step 324 can be replaced with Step 325 to determine if the number of updates of the estimated rates Pe has reached a threshold (expressed as Nmax). In other words, whether the number of iterations for performing Steps 326 has reached the threshold Nmax can be determined. The threshold Nmax can be set according to the number of updates of the estimated rates Pe in a training epoch. The rate adjustment method 500 can include the following steps.

Step 305: set the upper rate bound Pmax and the lower rate bound Pmin;

Step 310: the rate estimation model 130 can generate the plurality of estimated rates Pe according to the plurality of training data Dt, where each of the plurality of estimated rates Pe is between the upper rate bound Pmax and the lower rate bound Pmin;

Step 320: the revenue estimation model 140 can generate the estimated revenue Re according to the plurality of estimated rates Pe;

Step 322: determine if the estimated revenue Re has reached a predetermined revenue Rtarget; if so, enter Step 330; else, enter Step 325;

Step 325: determine if the number of updates of the plurality of estimated rates Pe has reached the threshold Nmax; if so, enter Step 330; else, enter Step 326;

Step 326: update the rate estimation model 130; enter Step 310;

Step 330: generate the optimal rate estimation model 130; and

Step 340: input the plurality of current data Dc into the optimal rate estimation model 130 to update the plurality of estimated rates Pe.

In Step 325, the number of updates of the estimated rates Pe can be related to the number of generating the estimated rates Pe. If the number of updates of the estimated rates Pe is n, the number of generating the estimated rates Pe can be (n+1), where n is an integer larger than zero.

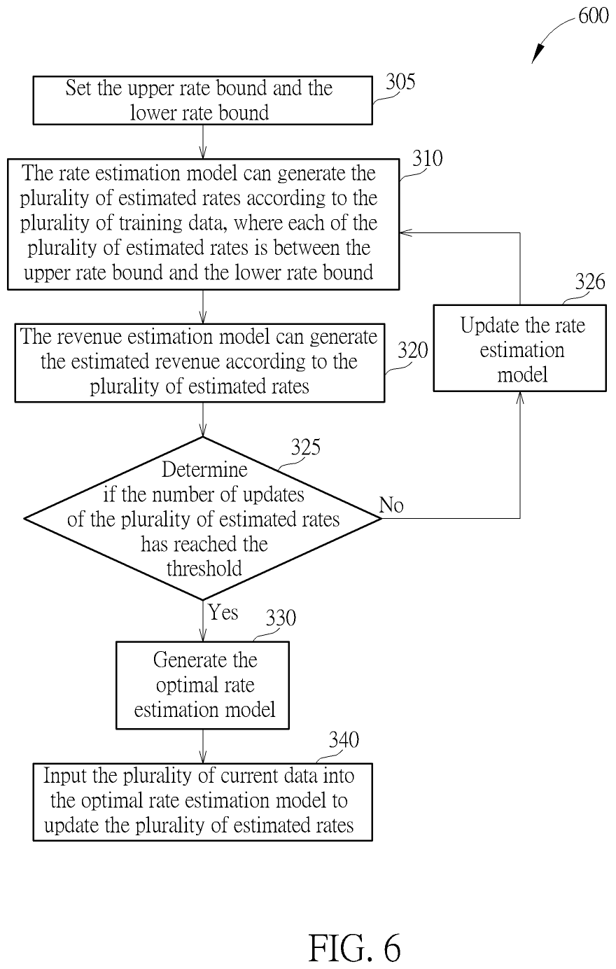

FIG. 6 illustrates a rate adjustment method 600 according another embodiment. The rate adjustment method 600 can be similar to the rate adjustment method 400, but Step 324 can be replaced with Step 325 in the rate adjustment method 600 to determine if the number of updates of the estimated rates Pe has reached the threshold Nmax. The rate adjustment method 600 can include following steps.

Step 305: set an upper rate bound Pmax and a lower rate bound Pmin;

Step 310: the rate estimation model 130 can generate the plurality of estimated rates Pe according to the plurality of training data Dt, where each of the plurality of estimated rates Pe is between the upper rate bound Pmax and the lower rate bound Pmin;

Step 320: the revenue estimation model 140 can generate the estimated revenue Re according to the plurality of estimated rates Pe;

Step 325: determine if the number of updates of the plurality of estimated rates Pe has reached the threshold Nmax; if so, enter Step 330; else, enter Step 326;

Step 326: update the rate estimation model 130; enter Step 310;

Step 330: generate the optimal rate estimation model 130; and

Step 340: input the plurality of current data Dc into the optimal rate estimation model 130 to update the plurality of estimated rates Pe.

Before training the rate estimation model 130, the upper rate bound Pmax, the lower rate bound Pmin and a base rate of the hotel room rate can be inputted as constraints for training the rate estimation model 130. Regarding the base rate, for example, an average, mode or median of a plurality of room rates in the historical data can be calculated to generate the base rate accordingly. The room rates in the historical data can be calculated with a proper equation to generate the base rate. When calculating the base rate, it can be rounded to tens, hundreds or appropriate digits.

When the rate estimation model 130 estimates the rates, machine learning is performed to consider the market environment, the rates provided by the competitors, and other relevant factors (e.g. various data in the training data Dt). A PPO (proximal policy optimization) algorithm, a PPO2 algorithm or other appropriate algorithms can be used to design an agent model (e.g. the rate estimation model 130) to increase or decrease the base rate to generate the estimated rates, and the estimated rates are between the upper rate bound Pmax and the lower rate bound Pmin. The range of decreasing or increasing the base rate can be expressed as a percentage of the base price.

When training the agent model (e.g. the rate estimation model 130), the agent model can adjust the rates in a preset range. When adjusting the rates, two operations, increasing the rates and decreasing the rates, can be performed. Two ranges can be set for these two operations respectively, so the trained agent model can adjust the rates in a predetermined range. Hence, when adjusting the rates, there may be implicit upper bound and lower bound changed with an initial rates. In addition, fixed upper bound and lower bound (e.g. the upper rate bound Pmax and the lower rate bound Pmin) can be set to limit the range of the final output rates.

In Step 240 in FIG. 2 and Step 340 in FIG. 3 to FIG. 6, when the current data Dc is inputted into the rate estimation model 130 to update the estimated rates Pe, it can be checked if the generated estimated rates Pe are between the upper rate bound Pmax and the lower rate bound Pmin. If so, old rates on the system (e.g. systems of reservation websites or online travel agencies) can be updated through an application programming interface (API) and be replaced with the rates generated according to the current data Dc.

For the training in an epoch, the number of updates of the rates and operation time of updating of the rates can be set. In an epoch, a plurality of estimated rates can be continuously generated, and a demand forecasting model (e.g. the revenue estimation model 140) can estimate the demand corresponding to each rate for calculating a total revenue in the epoch. The revenue of an epoch can be gradually increased after training the models (e.g. the rate estimation model 130 and the revenue estimation model 140) for multiple epochs, and an optimal agent model (e.g. the rate estimation model 130) can be generated. Instead of calculating a highest revenue with the rates generated at one time, a neural network (e.g. the rate estimation model 130) can be trained to maximize the revenue in a period (e.g. next 30 days).

In summary, through the rate adjustment system 100 and the rate adjustment methods 200, 300, 400, 500 and 600, various data such as weather data, news, economic data, data of competitors collected from online travel agencies, data of the sales terminal (e.g. sales and inventory) and so on can be used as factors for generating an optimal rate estimation model 130 with reinforcement learning. Hence, daily rates of items for sale (e.g. different types of hotel rooms, air tickets, etc.) can be updated in real-time to respond to changes of supply and demand in the market, and revenue can be optimized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rate adjustment method comprising:
a rate estimation model generating a plurality of estimated rates according to a plurality of training data;
a revenue estimation model generating an estimated revenue according to the plurality of estimated rates;
updating the rate estimation model according to the estimated revenue to generate an updated rate estimation model; and
inputting a plurality of current data into the updated rate estimation model to update the plurality of estimated rates.

2. The rate adjustment method of claim 1, further comprising:
setting an upper rate bound and a lower rate bound;
wherein the upper rate bound is higher than the lower rate bound, and each of the plurality of estimated rates is between the upper rate bound and the lower rate bound.

3. The rate adjustment method of claim 1, wherein the plurality of estimated rates comprise daily rates of a plurality of dates.

4. The rate adjustment method of claim 1, wherein the revenue estimation model generating the estimated revenue according to the plurality of estimated rates comprises:
if the plurality of estimated rates fail to comply with a predetermined rule, the revenue estimation model performing a penalty operation to generate a lower estimated revenue.

5. The rate adjustment method of claim 1, wherein:
the rate estimation model is no longer updated when the estimated revenue reaches a predetermined revenue.

6. The rate adjustment method of claim 1, wherein:
the rate estimation model is no longer updated when an operation time of updating the rate estimation model reaches a threshold.

7. The rate adjustment method of claim 1, wherein:
the rate estimation model is no longer updated when number of updates of the plurality of estimated rates reaches a threshold.

8. The rate adjustment method of claim 1, wherein the plurality of training data comprise weather data, news, economic data, historical sales data, and/or online travel agency data.

9. The rate adjustment method of claim 1, wherein the plurality of current data comprise weather forecast data, current news, current economic data, current sales data, and/or current online travel agency data.

10. A rate adjustment system comprising:
a training data module configured to provide a plurality of training data;
a current data module configured to provide a plurality of current data;
a rate estimation model linked to the training data module and the current data module, and configured to receive the plurality of training data and the plurality of current data, generate a plurality of estimated rates according to the plurality of training data, and update the plurality of estimated rates according to the plurality of current data; and
a revenue estimation model configured to generate an estimated revenue according to the plurality of estimated rates and generate an updated estimated revenue after the plurality of estimated rates are updated;
wherein each of the rate estimation model and the revenue estimation model has a neural network, and the rate estimation model is updated according to the estimated revenue for optimizing the rate estimation model.
